(19) United States
(12) Patent Application Publication
(10) Pub. No.: US 2006/0129468 A1
(43) Pub. Date: Jun. 15, 2006

(54) Financial management system

(76) Inventors: Hugh Owen Lovesy, Alice Springs (AU); Michael Joseph Arundell, Alice Springs (AU); Christopher Fraser, Alice Springs (AU)

Correspondence Address: SEYFARTH SHAW LLP, 55 E. MONROE STREET, SUITE 4200, CHICAGO, IL, 60603-5803, US

(21) Appl. No.: 10/528,755

(22) PCT Filed: Sep. 29, 2003
(86) PCT No.: PCT/AU03/01287

§ 371 Date: Oct. 19, 2005

(30) Foreign Application Priority Data
Sep. 27, 2002 (AU) 2002951706

(51) Int. Cl. G06Q 40/00

(52) U.S. Cl. 705/35

(57) ABSTRACT

A financial management system including presentation means for presenting financial information to a user wherein at least some of the financial information is represented by at least one graphic, manipulation means for manipulating the at least one graphic in response to an action of a user, and modifying means for modifying the financial information based on the manipulation of the at least one graphic.

### TECHNICAL FIELD

This invention relates to financial management systems and particularly those embodied in computer hardware or software.

### BACKGROUND OF THE INVENTION

Many people do not have a clear understanding of the fundamental principles and concepts which underlie the management of finances and find interpreting numerical accounts reports to be very difficult. To assist with this, some financial management systems provide accounts reports that are expressed with the aid of graphics such as graphs or charts. However, the user is required to operate the system by working exclusively with numerical data in order to produce such a graphical report. Thus, a level of competence and understanding of numerical accounts information is still required to operate systems of these types.

### SUMMARY OF THE INVENTION

In a first aspect the present invention provides a financial management system including: presentation means for presenting financial information to a user wherein the financial information includes a planned value in respect of a pre-determined period of time, a target value being a proportion of the planned value at a pre-determined point during the period of time, and an actual value as at the pre-determined point during the period of time, each of the planned value, the target value and the actual value being represented by a graphic; the graphics are associated with one another so that the variance between the target value and the actual value is visually apparent to the user; the system further including manipulation means for manipulating at least one of the graphics in response to an action of a user; and modifying means for modifying the financial information based on the manipulation of the at least one graphic.

By use of this system, financial information can be worked upon whilst it is represented in a graphical format because manipulation of the graphic results in a change to the financial information that the graphic represents. The use of graphics makes operation of the system open to those who do not have a clear understanding of financial information when it is represented wholly numerically and may also improve ease of use even for those who are comfortable with interpreting purely numerical financial information.

In this specification the term “graphic” denotes-a pictorial representation of information as opposed to representation by a series of numbers or text characters.

The value of the financial information that the at least one graphic represents may be proportional to a dimension of the graphic and the graphic may be manipulated by being resized.

The value of the financial information that the at least one graphic represents may correspond to the position of the graphic and-the graphic may be manipulated by being moved.

The system may further include creation means for creating a graphic and the financial information represented by that graphic.

The system may further include means for generating icons indicative of positive and negative financial status.

The system may further include means for storing the financial information.

The system may further include means for substituting the at least one graphic by an alternative graphic. This allows a user to select the graphical format that is most easily understood by them or most appropriate for their needs.

The means for presenting the financial information may represent the financial information wholly numerically. In this way, the system can output financial information in a wholly numerical format for use by persons who have an understanding of wholly numerical financial reports. Thus, by use of the system a user can receive numerical financial information such as from their accountant, manipulate the information by use of graphics, and then represent the modified information numerically for sending back to their accountant.

The system may further include means for generating icons representative of budget items within an overall budget.

The system may further include means for associating a graphic with each icon whereby that budget item can be modified by manipulating the graphic.

The system may further include means for generating icons representing a time period over which a budget is to extend.

In a second aspect the present invention provides a method of managing financial information including the steps of: presenting financial information to a user wherein the financial information includes a planned value in respect of a pre-determined period of time, a target value being a proportion of the planned value at a pre-determined point during the period of time, and an actual value as at the pre-determined point during the period of time, each of the planned value, the target value and the actual value being represented by a graphic; associating the graphics with one another so that the variance between the target value and the actual value is visually apparent to the user; manipulating at least one of the graphics in response to an action of a user; and modifying the financial information based on the manipulation of the at least one graphic.

The step of manipulating the at least one graphic may further include the step of resizing the graphic.

The step of manipulating the at least one graphic may further include the step of moving the graphic.

The method may further include the step of creating a graphic and the financial information represented by that graphic.

The method may further include the step of generating icons indicative,of positive and negative financial status.

The method may further include the step of storing the financial information.

The method may further include the step of substituting the at least one graphic by an alternative graphic.

The method may further include the step of representing the financial information wholly numerically.

The method may further include the step of generating icons representative of budget items within an overall budget.

The method may further include the step of associating a graphic with each icon whereby that budget item can be modified by manipulating the graphic.

The method may further include the step of generating icons representing a time period over which a budget is to extend.

In a third aspect the present invention provides a computer program arranged to instruct a computing system to implement a system according to the first aspect of the invention.

In a fourth aspect the present invention provides a computer readable medium carrying a computer program according to the third aspect of the invention.

### BRIEF DESCRIPTION OF THE DRAWINGS

An embodiment of the present invention will now be described, by way of example only, with reference to the accompanying drawings, in which:

FIG. 1 is a schematic representation of a personal computer used to implement a system according to the present invention;

FIG. 2 is an illustration of financial information presented to a user by an embodiment of a system according to the present invention;

FIG. 3 is an illustration of an alternative set of financial information being presented to a user by the system used for FIG. 2;

FIG. 4 is an illustration of the financial information being presented in FIG. 2, but in a wholly numerical format;

FIG. 5 is an illustration of an alternative set of financial information presented to a user by the same system used for FIG. 2; and

FIG. 6 is another illustration of still a further set of financial information presented to a user by the same system used for FIG. 2.

### DESCRIPTION OF THE PREFERRED EMBODIMENT

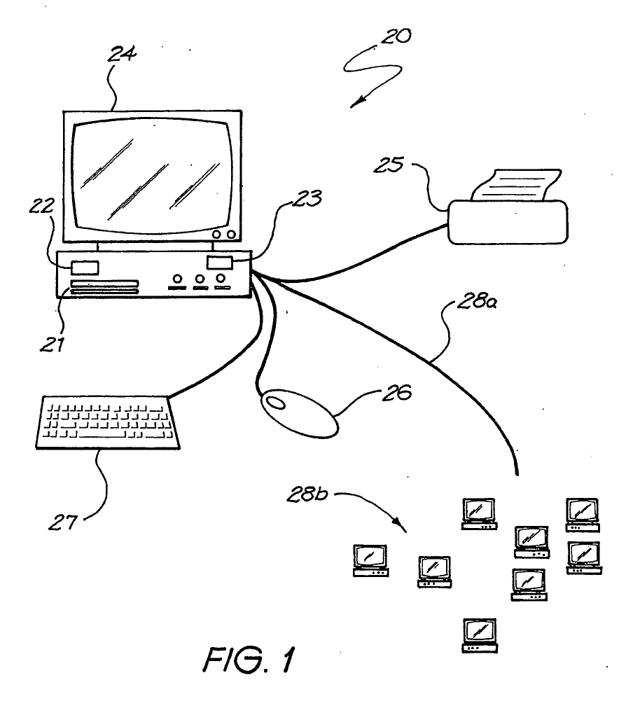

Referring to FIG. 1, a personal computer 20 suitable for implementing systems according to embodiments of the present invention is shown. Computer 20 operates under the instruction of a software program stored on hard disk data storage device 21. Computer 20 further includes a processor 22, memory 23, display screen 24, printer 25 and input devices mouse 26 and keyboard 27. The computer may have communications means such as a network connection 28a to the internet 28b to facilitate transfer and sharing of data.

The system of this embodiment includes storage means in the form of a combination of hard drive 21 and memory 23. The system includes presentation means in the form of a display screen 24 which displays a screen image under the control of a video output of computer 20. The system includes manipulation means embodied in software which communicates with mouse 26 and keyboard 27 to allow a user to manipulates a graphic on display screen 24. The system includes creation means embodied in computer software arranged to create a graphic and the financial information represented by that graphic. The system stores financial information in the storage means and includes modification means embodied in software that modifies the stored financial information based on the manipulation of the graphic. The display presented to the user is frequently updated by refreshing the image on display screen 24 to reflect the modifications made to the financial information.

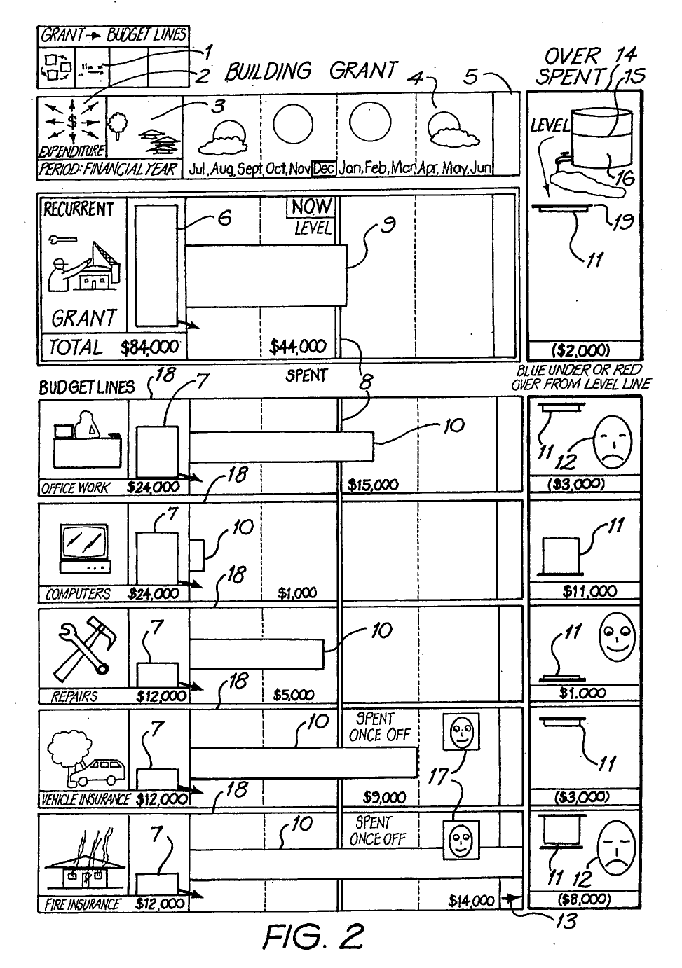

The system will be conveniently explained by reference to an illustrative embodiment. Referring to FIG. 2, an example of financial information being presented to a user of the system is shown where some of the financial information is represented graphically. In this example, the financial information relates to budgeting the spending of a building grant awarded to an Australian Aboriginal community and the financial information is presented to a user in the form of a financial report.

Level indicator 1 includes an icon which represents the level of the organisation to which the report relates. In this example the level of the organisation is indicated as a single cost centre or budget area by an icon showing a single building.

Report type indicator 2 includes an icon which represents the type of information that is being presented in the report. In this example an expenditure report is indicated by an icon indicating outgoing money.

Organisation graphic 3 indicates the particular organisation to which the report relates. This graphic is selected by or on behalf of the entity to which the report relates. In this example the graphic is selected by the Aboriginal community and is used in relation to all reports that concern that community.

Report period graphic 4 indicates the period to which the report relates. In this example the period is for the Australian financial year and is represented by positions of the sun during the four seasons of the year in a non tropical location.

Post report period graphic 5 indicates a time period following the report period. In this example it is the first month of the financial year following the year indicated by report period graphic 4.

Full year grant bar graph 6 is scaled so that its height is proportional to the full year building grant that has been allocated to the community. The actual financial amount is represented numerically below the bar graph.

Budget lines 18 summarise information relating to budgeted activities within the full year grant 6.

Full year budget bar graphs 7 are scaled in height in proportion to the size of the budget which has been allocated to the particular activity such as “Office Work, “Computers” etc. Again, the corresponding financial amount is represented below each bar graph.

Year to date budget line 8 indicates at what point in time the year to date budget is being assessed. In this example, the year to date budget line 8 intersects the period graphic 4 at the month indicated by the graphic “Dec”. This indicates that the year to date budget is being assessed at the month of December.

Year to date actual bar graphs 10 are horizontal bar graphs where the length of the bar indicates the proportion of the full year budget 7 for that item that has actually been spent to date. If the year to date actual bar graph 10 extends to the right of year to date budget line 8 then this indicates that the expenditure to date exceeds that which was budgeted for. The part of year to date actual bar graph 10 that extends to the right of year to date budget line 8 may be coloured red-or any other suitable colour to alert a user to the over budget condition. If the year to date actual expenditure for an activity exceeds the full year budget amount then year to date actual bar graph 10 extends into post period graphic 5. If the year to date actual expenditure for an activity exceeds 13/12ths of the full year budget amount this over budget condition is brought to the attention of a user by the presence of arrow 13. Arrow 13 may be coloured red to highlight the over budget condition.

Year to date actual total bar graph 9 is a horizontal bar graph. The length of bar graph 9 indicates the total expenditure to date as a proportion of the full year grant 6. Total year to date actual bar graph 9 is a summary of year to date actual bar graphs 10.

Variance indicator bar graphs 11 give an indication of the degree of variance between actual expenditure to date and budgeted expenditure to date. The height of the bar graph is proportional to the ratio of the variance to the budgeted amount. If the bar graph extends upwardly from the baseline 19 this indicates that actual spending is below the budgeted amount. If the bar graph extends downwardly from the baseline this indicates that actual spending is above the budgeted amount. *Bar graphs extending downwardly may be coloured red or another suitable colour to alert a user to the over budget condition. The actual variance amounts are represented numerically below the,respective variance indicator bar graphs.

Some of the information already discussed in the report is shown in an alternative graphical format by tank graphic 14. The total volume of the tank indicated by tank graphic 14 represents the total annual grant 6. The target line 15 represents the year to date budget 8. The liquid remaining 16 in the tank represents the amount of the total annual grant that currently remains unspent this being the total year to date actual subtracted from the total annual grant 6. The difference in height between the top of the liquid remaining 16 and target line 15 represents the year to date variance. The user can select in what graphical form the financial information is displayed and can substitute an existing graphic for an alternative graphic, each representing the same information. Year to date actual bar graphs 10 could be substituted by tank type graphics.

Emphasis indicators, in this example in the form of icons, are used to draw the users attention to particular points of positive or negative financial status. Negative emphasis indicators 12 draw attention to an over budget condition. Positive emphasis indicators 17 are positioned next to two year to date actual bar graphs 10 together with the-text “Spent Once Off”. They indicate that once off expenditure items have been recorded in a recurrent budget. Thus, the over expenditure indicated by year to date actual bar graphs 10 is not of particular concern because no further expenditure for these activities will be made during the remainder of the period.

Now that the structure of the report, and the meanings of the various graphical elements has been explained, it will be described, with reference to the illustrated example, how a user may operate the system by the manipulation-of graphics.

Creating A Budget Plan

The user, in this example being a member of the council of the Aboriginal community, is reviewing a government grant for the new financial year. They enter the purpose and the amount of the grant into the system and a report of the type shown in FIG. 2 is displayed. At this stage, no budget lines 18 are present in the report.

The user creates budget lines 18 by selecting a command “create budget line”. This may be done by selecting from a drop down menu or clicking a toolbar icon as is well known in the art. The system then requires the user to select from a range of titles for the budget line such as “Office Work”, “Computers”, “Repairs” etc, each having an icon associated with it and representing the title. For instance, the title “Repairs” is indicated by a collection of tradesman's tools. Alternatively, the user may create a new budget line title and select an appropriate icon to represent that budgeted activity. The system then requires the user to allocate a full year budget for this activity. The user does this by dragging up full year bar graph 7 to the desired height. During the dragging operation, the value of the full year budget, corresponding to the height of the bar graph is continuously updated as a numerical financial amount displayed beneath the full year bar graph,7. This can be used as a visual cue to the user when dragging top of full year bar graph 7 to the desired height. Additional budget lines 18 may be created in the same manner.

If the grant is for the same purpose as a grant that has already been entered into the system, such as for the previous financial year, then the report for the previous financial year may be displayed alongside the newly created report. The user may drag budget lines from the existing report to the new report thus obviating the need to select budget line titles and set full year budgets for the budget lines. Reference to the earlier financial report assists a user in providing all the relevant budget lines. It also assists a user in identifying what activities in the previous year went over or under budget. Thus assisting with the allocation of appropriate full year budget amounts.

When allocating budget amounts, the system alerts a user if they attempt to allocate more money than the value of the grant. Similarly, the system will inform the user of how much money remains unallocated. The system alerts the user if they are not permitted to alter the budget that they are attempting to alter according to privileges associated with their user name.

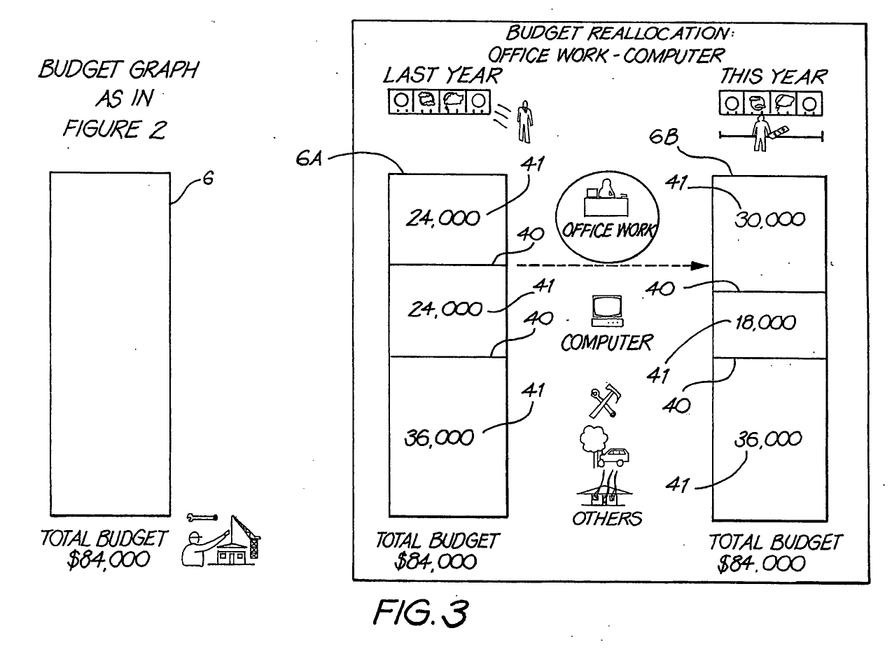

In the case of allocating full year budgets the user may use alternatives to dragging the budget graphs to the desired height. One alternative is illustrated in FIG. 3. The full year grant 6 is displayed at 6A as a bar divided with dividers 40 into segments 41. The size of each segment represents the full year budgets for a particular budget line shown in FIG. 2 (Office Work, Computer etc). To adjust budgets the user moves the dividers 40 on screen with use of a mouse to adjust the size of the segments 41. At 6B it can be seen that the divider between items “Office Work” and “Computer” has been moved downwards. This has the effect of increasing the amount budgeted for Office Work and at the same time reducing the amount budgeted for Computer. When changes are made in this way, the actuals 10 and variances 11 in the display of FIG. 2 change accordingly.

The system stores the financial information in a database in the storage means. The database is structured to store the financial information as a collection of discrete values and relationships. These values may be displayed either in a numerical or graphical format or a combination of these. These different formats own the same properties. The system allows the user flexibility of presentation to build the sorts of forms they may require.

The plans created by the operations detailed above may be compared to other plans or compared to actuals. Conversely, the operator may start with actuals which may be compared to plans previously prepared. Also these plans or actuals may be linked to targets, indicators, requirements and performances. The plan may be further revised or modified in a similar manner as circumstances require.

Modifying a Budget Plan

Referring again to FIG. 2, at any time after creating the budget plan, the full year budget amounts may be adjusted, for instance to reflect a revised estimate of the budget for a particular activity. This is done by clicking on the top of the full year bar graph 7 that is to be modified and resizing it accordingly. Again, a numerical financial amount is displayed below the bar graph to assist a user in performing the resizing operation. Any operation that changes the stored data or prints the stored data is logged in an audit trail.

Associating Spending with Budget Plan

When invoices or accounts payable are received, they are entered into the system. The information from each invoice line is entered into the database and stored as an object associated with an icon. An invoice line is an item in an invoice that may include a brief description of the item and an amount to be paid for that item. The most appropriate icon is selected by the user. Relationship data is also recorded by action of the user that identifies the budget line most closely related to the invoice line.

The icons associated with the invoice lines are displayed to he user. The user then drags the icons representing each invoice line to the budget line which most closely covers the goods or services to which each invoice line relates. If an icon is dropped onto a budget line that is inappropriate according to the predefined relationship data then a warning issues. When an invoice is associated with a budget line, the year to date actual bar graph changes its size to represent the changes that were made. The associated variance indicator bar graph 11 also changes to reflect the change.

Once an invoice has been dropped onto a budget line it can subsequently be moved to another budget line of the same category by dragging and dropping. This principle may be extended to other types of financial document and other types of graphical presentation. The user may subsequently inspect which invoice lines have been dropped onto a budget line by using a software command such as that known as “Magnifying Glass” and clicking on the budget line for which detailed invoice line information is required.

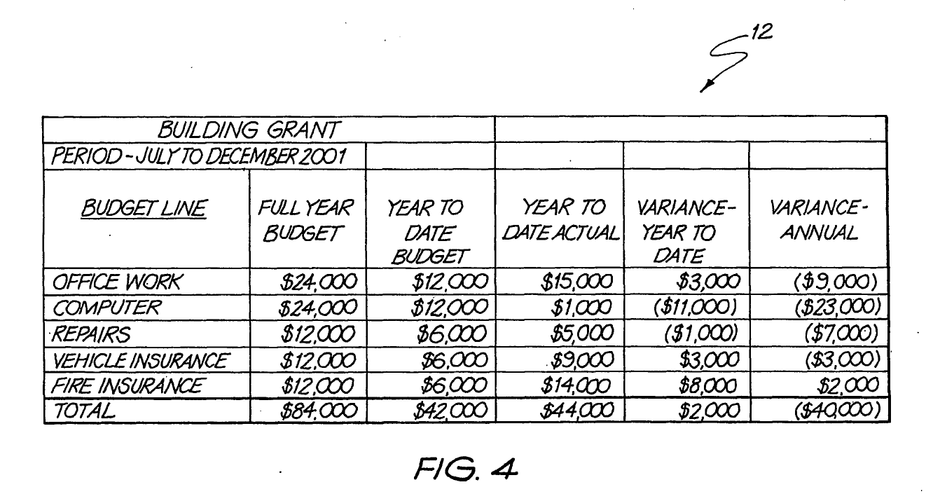

Referring to FIG. 4, the financial information that is being represented by FIG. 2 is shown wholly numerically in a table. At any time a user can instruct the system to represent the financial information stored in the database in a wholly numerical format. So, after working with the information in a graphical format the user may represent or output the financial information in a wholly numerical format. They may do this, for instance, to send the information to their accountant or the like who would be comfortable with and may indeed prefer to receive the financial information in a wholly numerical format.

The system is multiuser with all user access and editing rights tailored by association with user privileges. More than one installation of the system can access a common database over a communications link such as the internet. In two different places it can present the same financial information in two different formats simultaneously. In one place it may allow the user to display graphically while in another location at the same time it will allow another user to display numerically.

Whilst the above described embodiments related to planning a budget, other aspects of financial management can be conducted using the system of the present invention. For instance, it could be used to represent a wide range of financial reports including:
1. Grant Accounting and Budget Type Reports
Expenditure, Recurrent and Capital
Income
Expenditure Running Totals
Overviews
Overview Maps
Income and Expenditure Budget Checks
Overall Actuals Checks
2. Business Type Reports Which Include Gross Profit/Net Profit Reports, Costs, Stock Reports, Assets and Liabilities, Depreciation, And Stock And Profitability Over Time
3. Budgeting Kits
4. Coding Charts
5. Wages Slips
6. Rent Collection

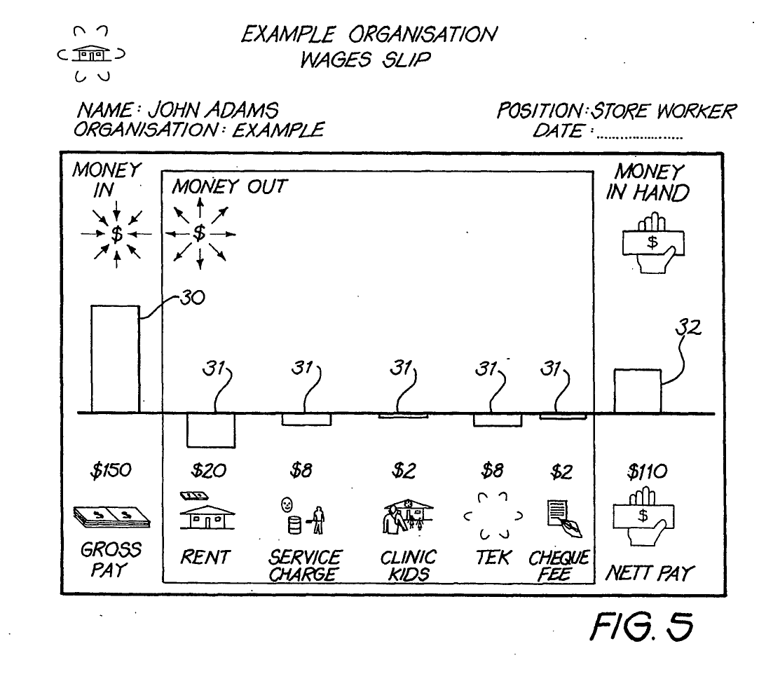

Referring to FIG. 5 an example of a wages slip as represented by an embodiment, of a system according to the invention is shown. Money in bar graph 30 represents the gross weekly pay of an employee “John Adams”. Money out bar graphs 31 represent deductions from the gross weekly pay for items including “Rent”, “Service Charge” etc. Money in Hand bar graph 32 represents the nett pay received by the employee and is calculated by subtracting the deductions from the gross weekly wage. The money in bar graph 30 may be manipulated to reflect the current weekly wage of the employee on a particular week. Similarly, the money out bar graphs 31 may be manipulated by dragging to adjust the height of the bars to reflect changes in regular weekly deductions. The money in hand bar graph 32 automatically adjusts in height to reflect the changes made to either money in bar graph 30 or money out bar graphs 31. The financial information being presented in the wage slip is stored and may be represented to the user in a wholly numerical format if desired.

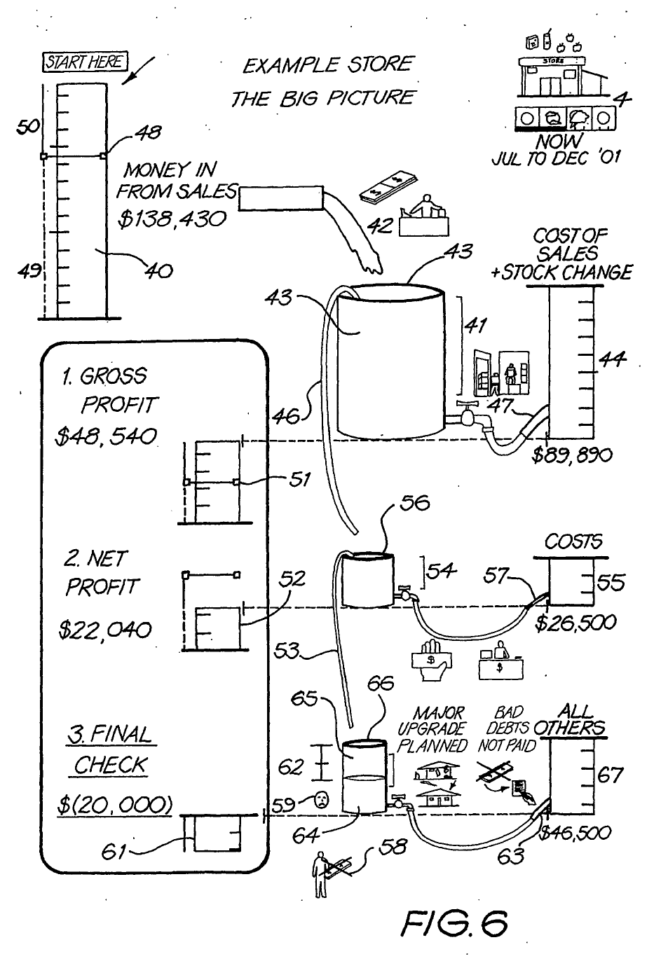

Referring to FIG. 6, an example of an overview of a financial report for a small business is shown, in this example the report relates to an example store. Report period graphic 4, indicates that the report relates to the period July 2001 to December 2001. The report shows that the Net Worth of the business has decreased by $20,000 over the period. In this example the graphical report is divided into three sections to reflect the financial report. These three areas are
1. Gross Profit section as indicated on a profit and loss report illustrated by tank 41 and the graphics that surround it
2. Net Profit as indicated on a profit and loss report illustrated by tank 54 and the graphics,that surround it
   3. Funds Available for distribution to shareholders/members etc as indicated on a profit and loss report and balance sheet illustrated by tank 60 and the graphics that surround it.
      1. Gross Profit.

In this example, in order to illustrate the principals involved in this graphical display as simply and clearly as possible, the size of the year to date budget tank for the gross profit section of the report, graphic 41, is set to equal the point at which income from sales is equal to cost of sales.

The actual sales income is illustrated by bar graph 40 and the cost of sales by bar graph 44. The cost of sales that need to be deducted from actual sales income sources is shown by the thin vertical line 49 to the left of the actual sales income bar graph 40. The targeted budget, here year to date budget for December 2001, is shown both by the line 48 that cuts across the income sales bar graph 40 and by the rim 43 of tank 41.

When this target has been exceeded the thin line 49 joins to another line of a different colour 50 indicating a gross profit situation. The length of this thin line 50 is the same as the height of the gross profit bar graph 51.

In addition, the actual sales income is directly proportional to the combined sum of the volume of liquid in the tank 43 and the thickness of the stream of liquid overflowing from the tank 46, where the volume of liquid filling the tank to the rim is equal to the targeted budget and the thickness of the stream of liquid 46 overflowing the rim 43 of the tank is proportional to the amount of the gross profit. Gross profit is the actual income that remains after the deduction of actual cost of sales.

Note also that the thickness of the outflow, through the tap, 47 is directly proportional to cost of sales.

2. Net Profit

The principles operating in this section are the same as those applicable to the gross profit section of this graphical report. Gross profit available for expenditure on costs is shown as the overflow 46 from tank 41 and as bar graph 51. Costs are shown as bar graph 55 and as liquid flowing from tank 54 via pipe 57. The budgeted amount for costs is shown by the size of tank 54. The net profit is shown by the thickness of overflow 53 that overflows the rim 56 of tank 54. Net profit is also shown as the bar graph 52.

3. Funds Available for Distribution to Shareholders/Members etc.

The principles operating in this section are the same as those applicable to the gross profit and net profit sections of this graphical report. The amount required to cover outgoings others is shown by the tank 60. The ‘Final. Check’ on the businesses position is shown by the bar graph 61 and by the absence of liquid overflowing the rim 66 of tank 60 as shown by the warning indicator 62. The heights of 61 and 62 are the same. This warning is further emphasised by the warning sign 59 below. The level of funds from net profit are shown as the volume of liquid 64 in tank 60. The short fall of funds from net profit 52 to the target amount as shown by the rim of tank 66 is shown as gap 65 between the top of the liquid 64 and the rim 66 of tank 64. Outgoings/provisions (in certain instances, liabilities etc.) are shown as the liquid flowing from tank 60 via pipe 33 and by the bar graph 67. The fact that no funds are available for distribution is shown by warning indicator 58 that is situated in the position where there would have been an overflow income stream if funds were to have been available.

Each section above of this financial report can be expanded as required, with extra pages. For instance, where businesses and organizations have budgets or targets for their costs, then actual costs 55 can be reported against budgeted costs as illustrated in FIG. 2. The same can be done for income 40.

This report may also be integrated into a larger graphical report such as in instances where this report relates to one particular department or division in an organization which has several departments or divisions.

In this example the combinations of graphical alterations that the user can make which act as numerical agents into a rules based database are complex. Examples include:
The actual sales income to date can be inputted into the system by dragging bar graph 40 to the desired height. This in turn resizes and appropriately alters all the graphics related to the resized graphic and alters the relevant numerical values in the database.

For instance, one of the consequences of resizing of bar graph 48 is that the level of liquid 64 in budget tank 60 is resized the equivalent amount.
The target/year to date budget can be adjusted by clicking with a mouse cursor on an edge of tank 41 and resizing the tank.

Systems according to preferred embodiments operate on a personal computer operating under the control of a software program. Conveniently, the software program is written in a programming language in which databases can be written and in which objects~can be manipulated such as Delphi or Interbase.

While the above described systems have been described as operating on a personal computer, it will appreciated by those in the art that any suitable computing device can be used such as a mobile or other computing device.

Whilst the above described example involved the user manipulating graphics with a computer mouse this can also be achieved by other user interfaces, such as touch screen, voice command or keyboard entry.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A financial management system including:
presentation means for presenting financial information to a user wherein the financial information includes a planned value in respect of a pre-determined period of time, a target value being a proportion of the planned value at a pre-determined point during the period of time, and an actual value as at the pre-determined point during the period of time, each of the planned value, the target value and the actual value being represented by a graphic;
the graphics are associated with one another so that the variance between the target value and the actual value is visually apparent to the user;
the system further including manipulation means for manipulating at least one of the graphics in response to an action of a user; and
modifying means for modifying the financial information based on the manipulation of the at least one graphic.

2. A financial management system according to claim 1 wherein the financial information that the at least one graphic represents is proportional to a dimension of the graphic and the graphic may be manipulated by being resized.

3. A financial management system according to claim 1 wherein the financial information that the at least one graphic represents corresponds to the position of the graphic and the graphic may be manipulated by being moved.

4. A financial management system according to claim 1 further including creation means for creating a graphic and the financial information represented by that graphic.

5. A financial management system according to claim 1 further including means for generating icons indicative of positive and negative financial status.

6. A financial management system according to claim 1 further including means for storing the financial information.

7. A financial management system according to claim 1 further including means for substituting the at least one graphic with an alternative graphic.

8. A financial management system according to claim 1 wherein the means for presenting the financial information can represent the financial information wholly numerically.

9. A financial management system according to claim 1 wherein the planned value is a budget and the system further includes means for generating icons representative of budget items within the budget.

10. A financial management system according to claim 9 further including means for associating a graphic with each icon whereby that budget item can be modified by manipulating the graphic.

11. A financial management system according to claim 9 further including means for generating icons representing the time period over which a budget is to extend.

12. A method of managing financial information including the steps of:
presenting financial information to a user wherein the financial information includes a planned value in respect of a pre-determined period of time, a target value being a proportion of the planned value at a pre-determined point during the period of time, and an actual value as at the pre-determined point during the period of time, each of the planned value, the target value and the actual value being represented by a graphic;
associating the graphics with one another so that the variance between the target value and the actual value is visually apparent to the user;
manipulating at least one of the graphics in response to an action of a user; and
modifying the financial information based on the manipulation of the at least one graphic.

13. A method according to claim 12 wherein the financial information that the at least one graphic represents is proportional to a dimension of the graphic and the step of manipulating the graphic includes the step of resizing the graphic.

14. A method according to claim 12 wherein the financial information that the at least one graphic represents corresponds to the position of the graphic and the step of manipulating the graphic includes the step of moving the graphic.

15. A method according to claim 12 further including the step of creating a graphic and the financial information represented by that graphic.

16. A method according to claim 12 further including the step of generating icons indicative of positive and negative financial status.

17. A method according to claim 12 further including the step of storing the financial information.

18. A method according to claim 12 further including the step of substituting the at least one graphic with an alternative graphic.

19. A method according to claim 12 further including the step of representing the financial information wholly numerically.

20. A method according to claim 12 A method according to claim 12 wherein the planned value is a budget and further including the step of generating icons representative of budget items within the budget.

21. A method according to claim 20 further including the step of associating a graphic with each icon whereby that budget item can be modified by manipulating the graphic.

22. A method according to claim 20 further including the step of generating icons representing a time period over which the budget is to extend.

23. (canceled)

24. (canceled)
